(19) United States
(12) Patent Application Publication
(10) Pub. No.: US 2009/0271610 A1
(43) Pub. Date: Oct. 29, 2009

(54) Multi-Function Apparatus and Method of Restricting Use of Multi-Function Apparatus

(75) Inventor: Satoshi KOTAKA, Azumino-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/420,682

(22) Filed: Apr. 8, 2009

(30) Foreign Application Priority Data
Apr. 28, 2008 (JP) 2008-117218

(51) Int. Cl. G06F 9/00; H04L 9/32

(52) U.S. Cl. 713/100; 726/2

(57) ABSTRACT

A multi-function apparatus which has plural functions includes: an authentication information acquiring unit which acquires authentication information on a user desiring to use the functions by use of an authentication information inputting unit; a use restriction unit which determines whether the user desiring to use the functions has use authority on the basis of the acquired authentication information, and permits the user to use the functions on condition of determining that the user has the use authority; an operation determination unit which determines whether at least one of the authentication information inputting unit, the authentication information acquiring unit, and the use restriction unit normally operates; and a setting change unit which changes setting of the use restriction unit on the basis of an input from the user by executing transfer to a setting change mode on condition that an operation of the transfer to the setting change mode is executed by the user, when the unit determined not to normally operate is present.

### BACKGROUND

1. Technical Field

The invention relates to a multi-function apparatus having plural functions.

2. Related Art

In the past, as a multi-function apparatus capable of executing plural functions such as an image forming function, an image reading function, and a fax communication function, there was known a multi-function apparatus which has a use restriction function (log-in function) which is based on user authentication so as to permit only qualified users to use the multi-function apparatus in terms of security (see JP-A-2006-215770). This multi-function apparatus includes various units (such as an authentication device such as a card reader, an interface communicating with an authentication server through a communication network, and a driver for controlling the authentication device and the interface) executing a log-in function.

When an administrator (a user having a management authority) is in a log-in state in the known multi-function apparatus having the log-in function, the administrator could switch between validity and invalidity of the log-in function.

When the log-in cannot be executed due to an obstacle to various units executing the log-in function in a state where the log-in function is set to be valid, even a qualified user cannot continue to use the multi-function apparatus. In this case, even though the qualified user is permitted to continue to use the multi-function apparatus by invalidating the log-in function by the administrator, the administrator cannot also log in the multi-function apparatus and thus cannot invalidate the log-in function so as to permit the qualified user to continue to use the multi-function apparatus.

In the past, when this problem occurred, the multi-function apparatus was first re-activated. In addition, when the obstacle was not restored, a repair person of the manufacturer of the multi-function apparatus needed to exchange or repair a hardware unit. Therefore, since users could not use the multi-function apparatus until the multi-function apparatus was exchanged or repaired, the user had to suffer inconvenience.

### SUMMARY

An advantage of some aspects of the invention is that it provides a new technique capable of continuing to use a multi-function apparatus by flexibly changing configuration of a log-in function, even when an obstacle occurs in units executing the log-in function in the multi-function apparatus having the log-in function.

According to an aspect of the invention, there is provided a multi-function apparatus which has plural functions and which includes: an authentication information acquiring unit which acquires authentication information on a user desiring to use the functions by use of an authentication information inputting unit; a use restriction unit which determines whether the user desiring to use the functions has use authority on the basis of the acquired authentication information, and permits the user to use the functions on condition of determining that the user has the use authority; an operation determination unit which determines whether at least one of the authentication information inputting unit, the authentication information acquiring unit, and the use restriction unit normally operates; and a setting change unit which changes setting of the use restriction unit on the basis of an input from the user by executing transfer to a setting change mode on condition that an operation of the transfer to the setting change mode is executed by the user, when the unit determined not to normally operate is present.

With such a configuration, it is possible to transfer to the setting change mode without use restriction of the use restriction unit and change the setting of the use restriction unit, when at least one of the authentication information inputting unit, the authentication information acquiring unit, and the use restriction unit does not normally operate.

In the multi-function apparatus according to this aspect of the invention, the setting change unit may set the use restriction unit to be invalid on the basis of the input from the user in the setting change mode.

In the multi-function apparatus according to this aspect of the invention, the use restriction unit may transmit an authentication request including the acquired authentication information to an authentication server, may receive information on authentication success or failure from the authentication server in reply to the authentication request, and may determine whether the user desiring to use the function has the use authority on the basis of the information on authentication success or failure. The operation determination unit may determine that the use restriction unit does not normally operate, when the use restriction cannot receive the information on authentication success or failure due to an obstacle of the authentication server or a communication network. In addition, the setting change unit may change a destination of the authentication request on the basis of the input from the user in the setting change mode, when the operation determination unit determines that the use restriction unit does not normally operate.

With such a configuration, since the use restriction unit can be made invalid or the destination of the authentication request can be changed in the setting change mode, the user can continue to use the functions of the multi-function apparatus without the use restriction of the use restriction unit by use of the authentication server which normally operates.

In the multi-function apparatus according to this aspect of the invention, an operation of the transfer to the setting change mode may include an input operation of an administrator password. With such a configuration, since only an administrator can allow the multi-function apparatus to execute the transfer to the setting change mode, it is possible to prevent a user other than the administrator from changing the setting on the use restriction unit.

According to another aspect of the invention, there is provided a method of restricting use of a multi-function apparatus which has plural functions, the method including: acquiring authentication information on a user desiring to use the functions by use of an authentication information inputting unit; determining whether the user desiring to use the functions has use authority on the basis of the acquired authentication information, and permitting the user to use the functions on condition of determining that the user has the use authority; determining whether at least one of the authentication information inputting unit, the authentication information acquiring unit, and the use restriction unit normally operates; and changing setting of the use restriction unit on the basis of an input from the user by executing transfer to a setting change mode on condition that an operation of the transfer to the setting change mode is executed by the user, when the unit determined not to normally operate is present.

The method according to this aspect of the invention can be realized by a CPU included in the multi-function apparatus. However, a program capable of executing the method can be installed or loaded through various media such as a CD-ROM, a magnetic disk, a semiconductor memory, and a communication network.

In the specification, units include units realized by hardware, units realized by software, and units realized by both hardware and software. In addition, one unit may be realized by two or more hardware units and two or more units may be realized by one hardware unit.

In the multi-function apparatus having the log-in function according to the aspects of the invention, there is provided a new technique capable of flexibly changing the setting of the log-in function and continuously using the multi-function apparatus, even when an obstacle occurs in the units executing the log-in function.

### BRIEF DESCRIPTION OF THE DRAWINGS

The invention will be described with reference to the accompanying drawings, wherein like numbers reference like elements.

FIG. 1 is a block diagram illustrating the overall configuration of an information processing system.

FIG. 2 is a diagram illustrating an example of function units included in a control unit.

FIG. 3 is a flowchart illustrating a process when a multi-function apparatus is activated.

FIG. 4 is a flowchart illustrating a process when a log-in function of the multi-function apparatus is invalid.

FIG. 5 is a flowchart illustrating a process when a log-in function of the multi-function apparatus is valid.

FIG. 6 is a flowchart illustrating a process when a log-in function of the multi-function apparatus is valid.

FIG. 7 is a flowchart illustrating a process when an error occurs in the log-in function of the multi-function apparatus.

FIG. 8 is a diagram illustrating an example of a basic function menu screen.

FIGS. 9A and 9B are diagrams illustrating examples of screens displayed when the error occurs in the log-in function, respectively.

FIGS. 10A to 10C are diagrams illustrating examples of destination selection screens of an authentication request, respectively.

### DESCRIPTION OF EXEMPLARY EMBODIMENTS

### First Embodiment

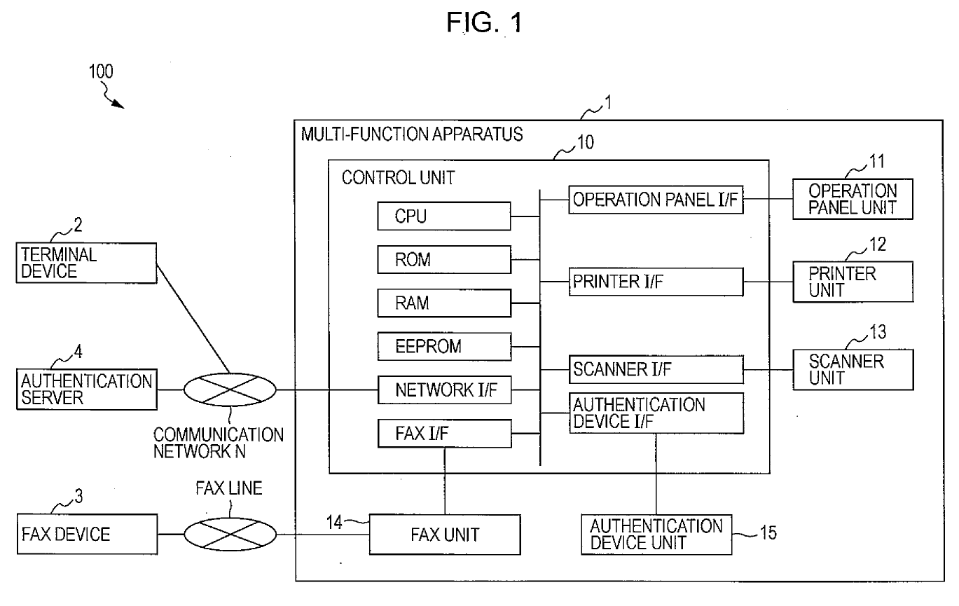

FIG. 1 is a block diagram illustrating the overall configuration of an information processing system 100 including a multi-function apparatus 1 according to an embodiment of the invention.

As shown in FIG. 1, the information process system 100 includes the multi-function apparatus 1, a terminal device 2 which is connected to the multi-function apparatus 1 through a communication network N to transmit a print job to the multi-function apparatus 1, a fax device 3 which is connected to the multi-function apparatus 1 through a fax line to transmit and receive fax data to and from the multi-function apparatus 1, and an authentication server 4 which is connected to the multi-function apparatus 1 through the communication network N to execute an authentication process.

In FIG. 1, one multi-function apparatus 1, one terminal device 2, one fax device 3, one authentication server 4 are illustrated. However, the information processing system 100 may include one or more multi-function peripheries, one or more terminal devices, one or more fax devices, and one or more authentication servers depending on a design thereof. In addition, the communication network N may be configured by a LAN, the Internet, a dedicated line, or a packet communication network, or by both a wired-line network and a wireless line network.

The multi-function apparatus 1 includes hardware units such as a control unit 10, an operation panel unit 11, a printer unit 12, a scanner unit 13, a fax communication unit 14, and an authentication device unit 15.

The configuration of each hardware unit is the same as that of a known multi-function apparatus. For example, the control unit 10 include a CPU, a memory (a ROM, a RAM, an EEPROM, or the like), an operation panel I/F, a printer I/F, a scanner I/F, a fax I/F, a network I/F, and an authentication device I/F, like a known control unit. As the authentication device unit 15, a card reader unit can be used, for example.

The CPU of the control unit 10 executes programs stored in the memory and controls the hardware units to realize function units of the multi-function apparatus 1.

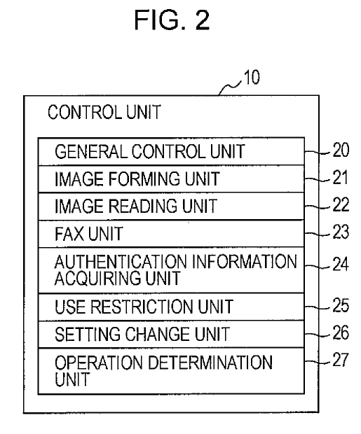

Representative function units of the multi-function apparatus 1 are illustrated in FIG. 2. As shown in FIG. 2, the multi-function apparatus 1 includes a general control unit 20 as a function of controlling the whole operations of the multi-function apparatus 1. As basic functions, function units such as an image forming unit 21, an image reading unit 22 and a fax unit 23 are included.

Like a known multi-function apparatus, the multi-function apparatus 1 includes, as use restriction functions (log-in function) which is based on user authentication, an authentication information acquiring unit 24 which acquires authentication information of a user (use desire user) desiring the basic functions of the multi-function apparatus 1 by use of an authentication device unit 15; a use restriction unit 25 which determines whether the use desire user has use authority on the basis of the acquired authentication information and permits the use desire user to use the basic functions on condition that the use desire user has the use authority; and a setting change unit 26 which executes transfer to a setting change mode and change setting of the multi-function apparatus 1 on the basis of an input from the user on condition that the an operation of the transfer to the setting change mode is executed by the use desire user, when the basic functions are permitted to be used.

However, the multi-function apparatus 1 according to this embodiment has the configuration different from that of a known multi-function apparatus, in that the multi-function apparatus 1 further includes an operation determination unit 27 which determines whether the authentication device unit 15, the authentication information acquiring unit 24, and the use restriction unit 25 normally operate and in that the setting change unit 26 executes transfer to the setting change mode on condition that an operation of the transfer to the setting change mode is executed by the use desire user and executes the setting change on the basis of an input from the use desire user, when there is a unit that does not normally operate.

Here, the setting change mode is a mode in which an administrator (a user having management authority of the multi-function apparatus 1) executes various kinds of setting on the multi-function apparatus 1. Accordingly, the operation of the transfer to the setting change mode includes an operation executed only by the administrator, for example, an operation of inputting an administrator password.

The multi-function apparatus 1 (the setting change unit 26) according to this embodiment is configured so that the use restriction unit 25 can set a use restriction pattern in the setting change mode.

Specifically, as the use restrictions pattern by the use restriction unit 25, it is possible to set (1) a pattern (which is a pattern for allowing the use restriction unit 25 to be valid) used to permit use of the multi-function apparatus 1 to only a user succeeding in authentication among direct operation users that directly operate the multi-function apparatus 1 through the operation panel unit 11, (2) a pattern (which is a pattern for allowing the use restriction unit 25 to be partially valid) used to permit the use of multi-function apparatus 1 to a user succeeding in authentication among the direct operation users and to a remote operation user transmitting job information (such as a print job) from an external device such as the terminal device 2 to the multi-function apparatus 1, and (3) a pattern (which is a pattern for allowing the use restriction unit 25 to be invalid) used to permit the use of the multi-function apparatus 1 to all users. Information on the set use restriction pattern is stored in a non-volatile memory such as an EEPROM and the stored details are maintained even after the multi-function apparatus 1 is turned off.

The terminal device 2, the fax device 3, and the authentication server 4 included in the information processing system 100 all have the same configuration and functions as those of a known example. For example, the authentication server 4 has a function of executing an authentication process on the basis of an authentication request transmitted from the multi-function apparatus 1 and replying information on success or failure of the authentication as a result of the authentication process to the multi-function apparatus 1.

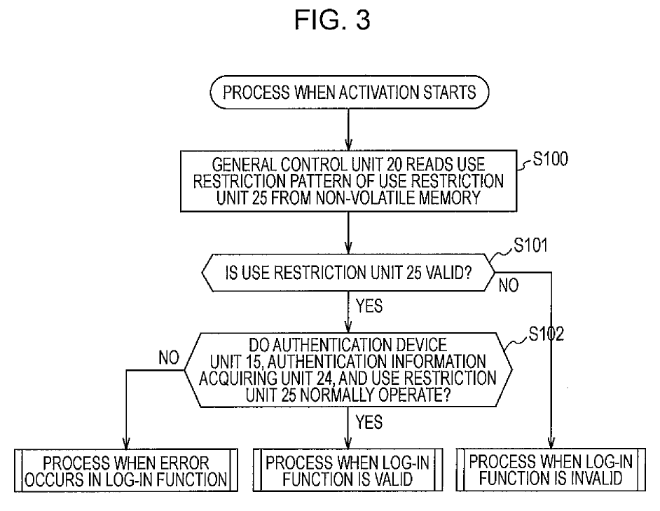

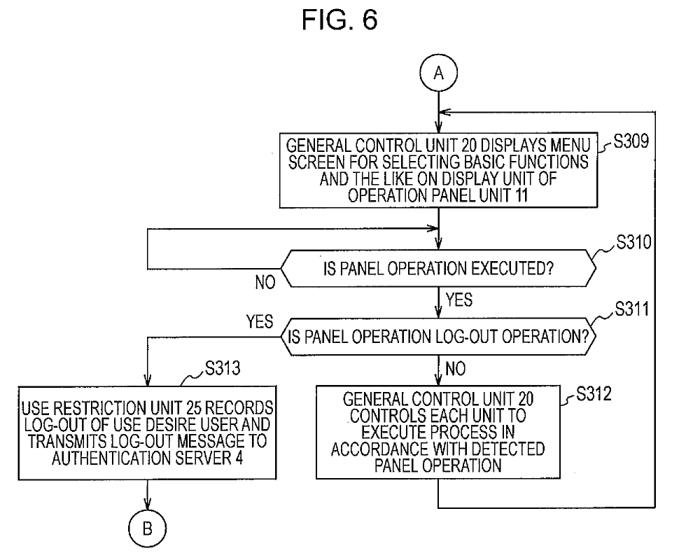

Hereinafter, various processes of the multi-function apparatus 1 will be described with reference to the flowcharts shown in FIGS. 3 and 6. In the specification, the processes (including partial processes to which reference numerals are not given) shown in the flowcharts may be arbitrarily changed in sequence or executed in a parallel manner to the extent that the processes are not contradictory to each other.

Processes when Activation Starts

The flowchart shown in FIG. 3 describes a process when the multi-function apparatus 1 is activated.

When the multi-function apparatus 1 is turned on, the general control unit 20 reads the use restriction pattern of the use restriction unit 25 from the non-volatile memory (S100).

Subsequently, the general control unit 20 determines whether the read use restriction pattern represents validity or invalidity of the use restriction unit 25 (S101).

Specifically, when the use restriction pattern of the use restriction unit 25 is the pattern (1) and the pattern (2) described above, the general control unit 20 determines that the use restriction pattern represents the validity of the use restriction unit 25. Alternatively, when the use restriction pattern is the pattern (3), the general control unit 20 determines that the use restriction pattern represents the invalidity of the use restriction unit 25.

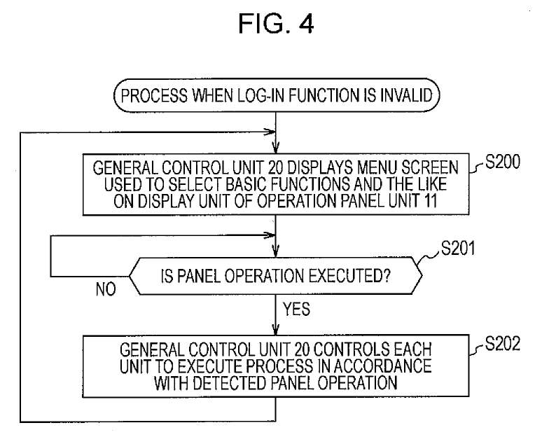

When the read use restriction pattern represents the invalidity of the use restriction unit 25, the general control unit 20 allows the process to proceed to a process executed when a log-in function shown in FIG. 4 is invalid.

Alternatively, when the read use restriction pattern represent the validity of the use restriction unit 25, the operation determination unit 27 determines whether the authentication device unit 15, the authentication information acquiring unit 24, and the use restriction unit 25 normally operate (S102).

For example, the operation determination unit 27 determines whether a status reply signal is received from the authentication device unit 15 in accordance with a status confirmation signal transmitted to the authentication device unit 15, and determines whether the authentication device unit 15 normally operates on the basis of whether the status reply signal presents normality, when the status reply signal is received. The operation determination unit 27 determines whether the authentication information acquiring unit 24 or the use restriction unit 25 normally operates in accordance with a checksum of a program or data regarding to each unit. The operation determination unit 27 determines whether the authentication information acquiring unit 24 normally operates on the basis of whether communication with the authentication server 4 is possible (for example, whether an obstacle occurs in the communication network N or the authentication server 4). In addition, whether each unit normally operates may be determined by various known methods in addition to the above-mentioned methods.

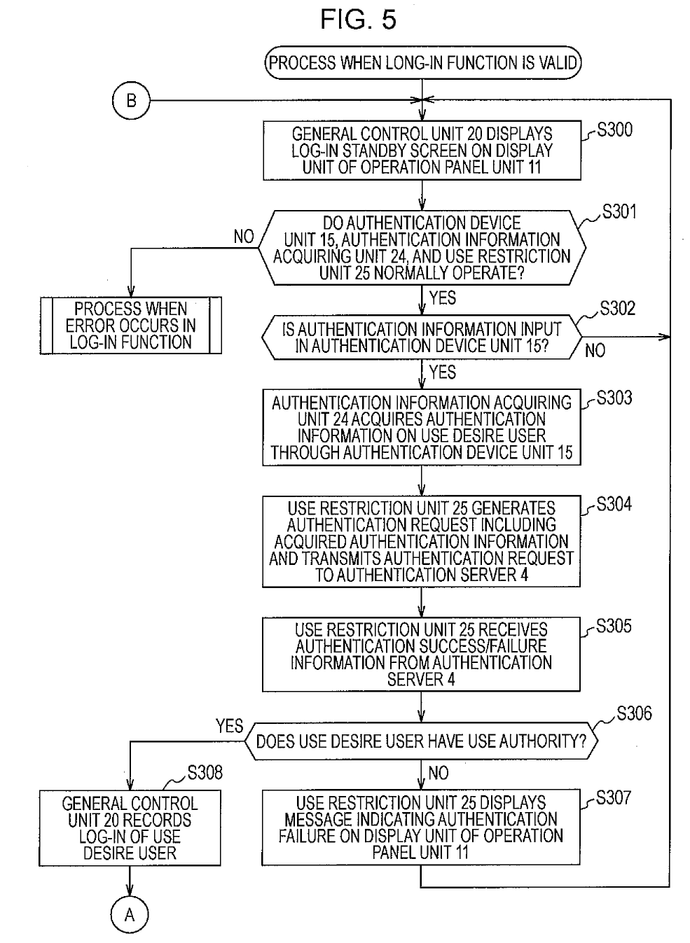

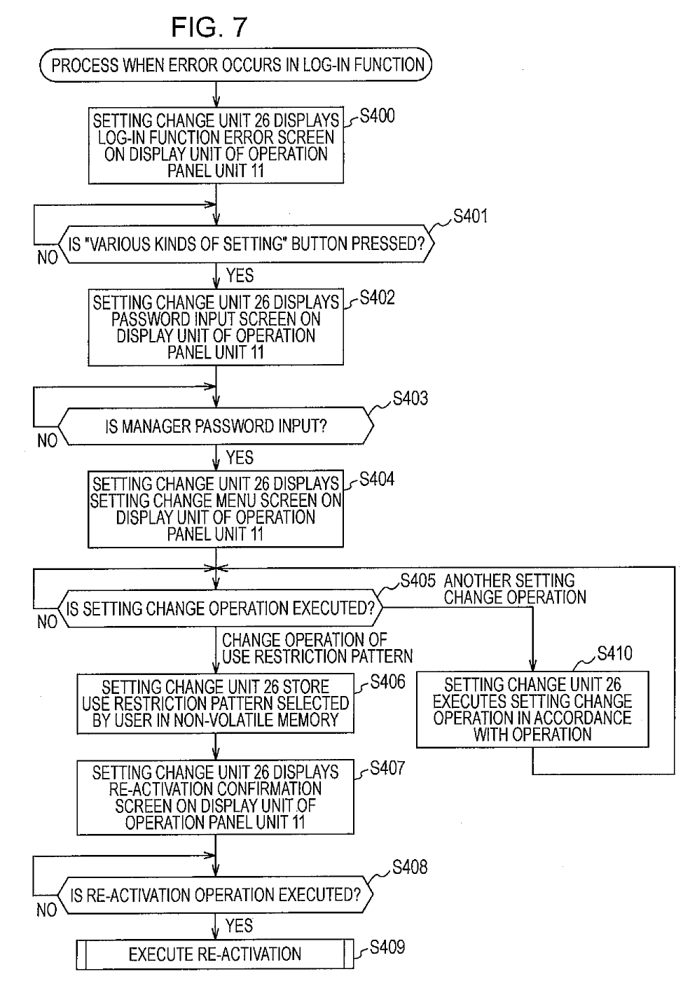

When the operation determination unit 27 determines that each unit normally operates, the process proceeds to the process executed when the log-in function shown in FIG. 5 is valid. Alternatively, when the operation determination unit 27 determines that several units do not normally operate, the process proceeds to a process executed when an error occurs in the log-in function shown in FIG. 7.

Process when Log-in Function is Invalid

FIG. 4 is a flowchart illustrating a process when the log-in function of the multi-function apparatus 1 is invalid.

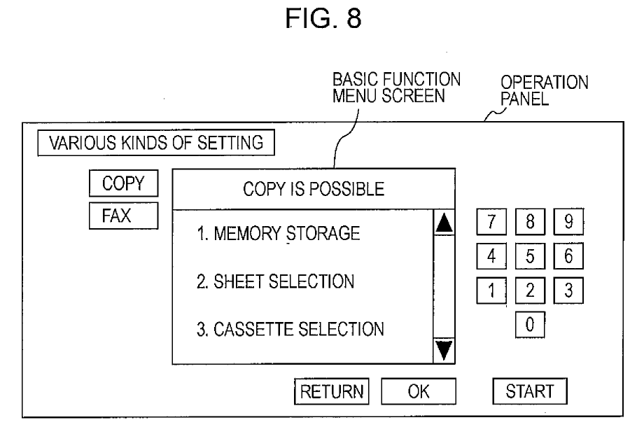

The general control unit 20 displays a menu screen used to select the basic functions or the like on a display unit of the operation panel unit 11 (S200) and waits a panel operation of the use desire user (S201). FIG. 8 is a diagram schematically illustrating an example of the operation panel displayed on a basic function menu screen.

When the panel operation of the use desire user is detected, the general control unit 20 executes a process in response to the detected panel operation (S202), like a known example. After the process ends, the process returns to S200.

Process when Log-in Function is Valid

The flowcharts shown in FIGS. 5 and 6, the process executed when the log-in function of the multi-function apparatus 1 is valid. In addition, when the log-in function is valid, a process executed when job information is received from an external device is the same as that of the known example, and thus the description is omitted.

The general control unit 20 displays a log-in standby screen on the display unit of the operation panel unit 11 (S300).

Subsequently, the operation determination unit 27 determines whether the authentication device unit 15, the authentication information acquiring unit 24, and the use restriction unit 25 normally operate (S301).

When the operation determination unit 27 determines that the several units normally operate, the process proceeds to the process executed when the error occurs in the log-in function shown in FIG. 6.

Alternatively, when the operation determination unit 27 determines that each unit normally operates, the authentication information acquiring unit 24 waits an operation of inputting the authentication information to the authentication device unit 15 by the use desire user (S302). When certain time elapses in a state where the authentication information is not input, the process returns to S300.

When the operation of inputting the authentication information to the authentication device unit 15 is executed, the authentication information acquiring unit 24 acquires the authentication information on the use desire user through the authentication device unit 15 (S303).

Subsequently, the use restriction unit 25 generates an authentication request including the acquired authentication information and transits the generated authentication request to the authentication server 4 (S304)

When the authentication server 4 receives the authentication request transmitted from the multi-function apparatus 1, the authentication server 4 executes the authentication process on the basis of the authentication request and replies information on authentication success or failure as a result of the authentication process to the multi-function apparatus 1, like the known example. When the authentication succeeds, the authentication server 4 records and manages the fact that a user corresponding to the authentication information logs in the multi-function apparatus 1.

When the information on authentication success or failure is received as a reply to the authentication request from the authentication server 4 (S305), the use restriction unit 25 determines whether the use desire user has the use authority on the basis of the information on authentication success or failure (S306).

When the information on authentication success or failure represents authentication failure, the use restriction unit 25 determines that the use desire user has no use authority and does not permit the use desire user to use the basic functions of the multi-function apparatus 1. Specifically, a message indicating the authentication failure is displayed on the display unit of the operation panel unit 11 (S307). When certain time elapses, the process is controlled to return to S300.

Alternatively, when the information on authentication success or failure represents authentication success, the use restriction unit 25 determines that the use desire user has the use authority and permits the use desire user to use the basic functions of the multi-function apparatus 1. Specifically, information indicating that the use desire user logs in the multi-function apparatus 1 is recorded in the memory of the multi-function apparatus 1 (S308). Then, the process is controlled to proceed to a process executed when the authentication succeeds.

In the process executed when the authentication succeeds, the general control unit 20 displays the basic function menu screen for selecting the basic functions or the like on the display unit of the operation panel unit 11 (S309) and waits the panel operation of the use desire user (S310). The basic function menu screen displayed in S309 is the same as that displayed in S201 in principle. In this case, the process executed when the log-in function is valid (the fact that the use desire user logs in) may be configured to be displayed by a display of the display unit or a lamp of the operation panel.

When the panel operation executed by the use desire user is detected, the general control unit 20 determines whether the detected panel operation is a log-out operation (S311).

Like the known example, when the detected panel operation is not the log-out operation, the general control unit 20 controls each unit to execute a process accompanied with the detected panel operation (S312). After the process ends, the process returns to S309.

Alternatively, when the detected panel operation is the log-out operation, the use restriction unit 25 records information indicating that the use desire user logs out the multi-function apparatus 1 in the memory of the multi-function apparatus 1 and generates a log-out message including the authentication information of the use desire user to transmit the log-out message to the authentication server 4 (S313). Therefore, the process of the multi-function apparatus 1 proceeds to S300.

Like the known example, when the authentication server 4 receives the log-out message transmitted from the multi-function apparatus 1, the authentication server 4 records and manages the fact that a user corresponding to the authentication information contained in the log-out message logs out the multi-function apparatus 1. Process When Error Occurs in Log-in Function

The flowchart shown in FIG. 7 illustrates the process executed when an error occurs in the log-in function of the multi-function apparatus 1.

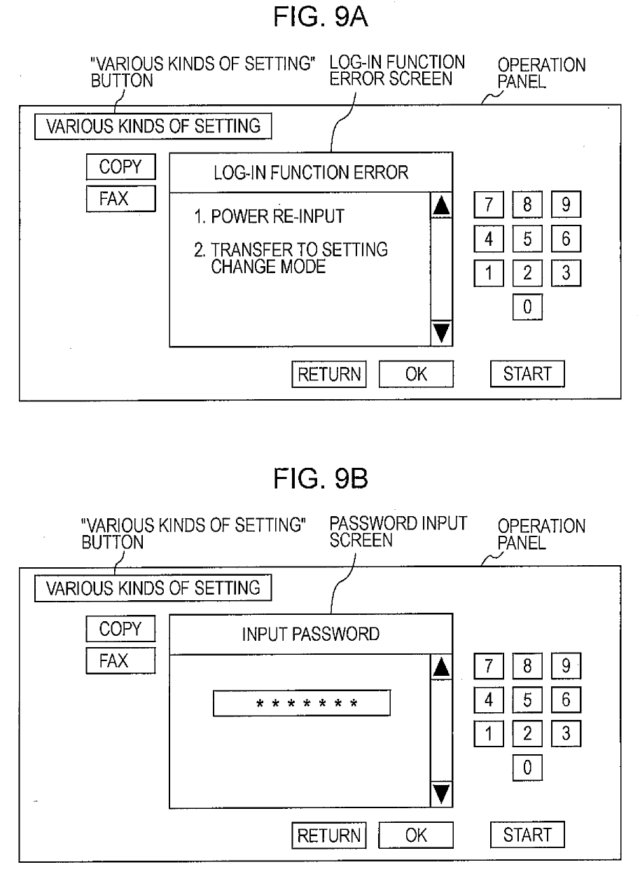

The setting change unit 26 displays a log-in function error screen on the display unit of the operation panel unit 11 in order to inform the user that an obstacle occurs in the log-in function (S400), and waits the operation of the transfer to the setting change mode. FIG. 9A is a diagram schematically illustrating an example of an operation panel displayed on the log-in function error screen. In this example, as options prompting the user to execute an operation, a first option “POWER RE-INPUT” used to execute re-activation of the multi-function apparatus I and a second option “TRANSFER TO SETTING CHANGE MODE” used to input an operation of the transfer to the setting change mode are displayed on the log-in function error screen.

In this embodiment, the operation of the transfer to the setting change mode is defined as an operation of pressing a “VARIOUS SETTING” button disposed in the operation panel unit 11 and a subsequent operation of inputting the administrator password.

The setting change unit 26 first waits the operation of pressing the “VARIOUS KINDS OF SETTING” button (S401). At this time, in order to prevent the basic functions of the multi-function apparatus 1 from being operated in the process executed when an error occurs in the log-in function, it is preferable that any operation other than the operation of pressing the “VARIOUS KINDS OF SETTING” button is not received.

When the operation of pressing the “VARIOUS KINDS OF SETTING” button by the user is detected, the setting change unit 26 displays a password input screen on the display unit of the operation panel unit 11 (S402), and waits an operation of inputting the administrator password (S403). FIG. 9B is a diagram schematically illustrating an example of the operation panel displayed on the password input screen.

When the operation of inputting the administrator password by the user (when an input password is identified with the administrator password stored in advance in the non-volatile memory), the setting change unit 26 allows the process to proceed to the setting change mode. Specifically, a setting change menu screen is displayed on the display unit of the operation panel unit 11 (S404) and waits various kinds of setting operations (S405).

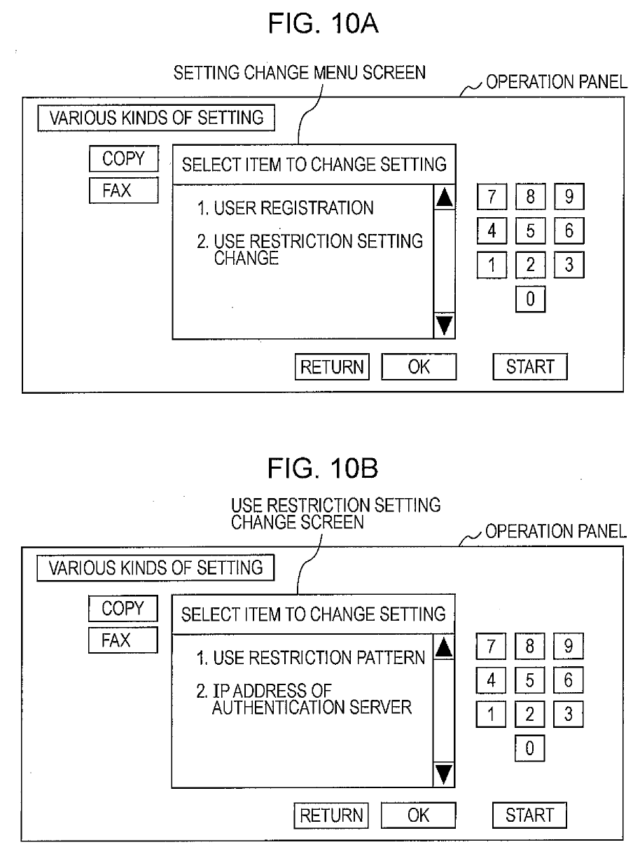

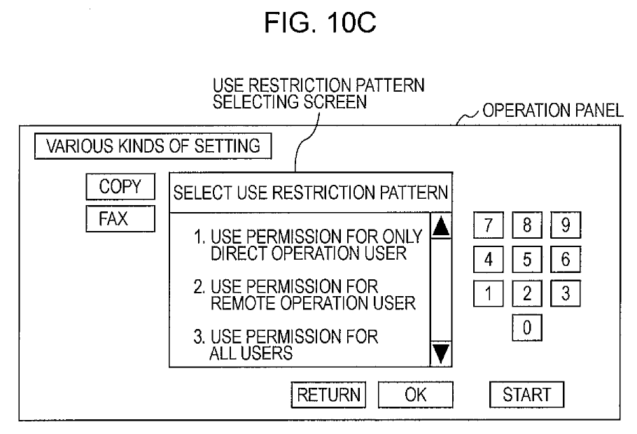

Here, the setting change unit 26 according to this embodiment is configured to receive an operation of changing the use restriction pattern by the use restriction unit 25 in S405. Specifically, an option “USE RESTRICTION SETTING CHANGE” used to execute the use restriction setting change is displayed on the setting change menu screen. When the user selects the option, the use restriction setting change screen is displayed on the display unit. An option “USE RESTRICTION PATTERN” used to change setting of the use restriction pattern of the use restriction unit 25 is displayed on the use restriction setting change screen. When the user selects the option, a use restriction pattern selecting screen is displayed on the display unit. The user can select and set one of the patterns (1) to (3) as the use restriction pattern of the use restriction unit 25 by using the use restriction pattern selecting screen. FIGS. 10A to 10C are diagrams schematically illustrating examples of operation panels on which the setting change menu screen, the use restriction setting change screen, and the use restriction pattern selecting screen are displayed, respectively.

When the operation of changing the use restriction pattern by the user is detected, the setting change unit 26 stores the use restriction pattern selected by the user in the non-volatile memory (S406).

Subsequently, the setting change unit 26 displays a re-activation confirmation screen on the display unit of the operation panel unit 11 (S407) and waits a re-activation operation (S408).

When the user executes the re-activation operation, the multi-function apparatus 1 is re-activated (S409). In consequence, a re-activation process is executed and it is determined whether the use restriction unit 25 is valid or invalid on the basis of the use restriction pattern of the use restriction unit 25 stored in the non-volatile memory in S406.

When other setting change operations are detected in S405, the setting change unit 26 executes a setting change process accompanied with each operation (S410).

The multi-function apparatus 1 is configured to determine whether each unit executing the log-in function normally operates before the activation process is executed or the authentication of the process executed when the log-in function is valid is executed. When it is determined that each unit does not normally operate, the transfer to the setting change mode is executed on condition that the operation of the transfer to the setting change mode is executed by the administrator, and the use restriction pattern of the use restriction unit 25 is changed.

With such a configuration, the administrator can execute the transfer to the setting change mode without use restriction of the use restriction unit 25 and can set and change to the use restriction pattern by use of the use restriction unit 25, even when an obstacle occurs in each unit executing the log-in function in a state where the log-in function is set to be valid. Accordingly, the administrator can select the use restriction pattern allowing the use restriction unit 25 to be invalid in the setting change mode. Thereafter, when the multi-function apparatus 1 is re-activated, the use desire user can continue to use the basic functions of the multi-function apparatus 1 without the use restriction of the use restriction unit 25.

### MODIFIED EXAMPLES

The invention is not limited to the above-described embodiment, but may be modified in various forms. For example, in the above-described embodiment, the multi-function apparatus having the image forming function, the image reading function, and the fax communication function as the basic functions is described. However, the invention is not limited to the multi-function apparatus having these basic functions. For example, even when a multi-function apparatus does not have the image reading function or the fax communication function, the invention can be also applied to a multi-function apparatus having plural printing functions, such as a both-side printing function, a one-side printing function, and a 2UP printing function, as an image forming function. The invention can be also applied to a multi-function apparatus having other functions other than the above functions.

In the above-described embodiment, the setting change unit 26 is configured to receive the operation of changing the use restriction pattern by the use restriction unit 25 in S405. In addition to or instead of this configuration, the setting change unit 26 may be configured to receive an operation of changing a destination of the authentication request in S405.

specifically, the setting change unit is configured as follows. That is, the option indicating the use restriction setting change is displayed on the setting change menu screen, as in FIG. 10A. When a user selects the option, a use restriction setting change screen is displayed on the display unit. An option “CHANGE IN IP ADDRESS OF AUTHENTICATION SERVER” indicating setting change of the destination of the authentication request is displayed on the use restriction setting change screen, as in FIG. 10B. When the user selects the option, an authentication request destination selecting screen is displayed on the display unit. The user can input an IP address of the authentication server or select the authentication server transmitting the authentication request by use of the authentication request destination selecting screen.

In this case, the setting change unit 26 stores the destination of the authentication request in the non-volatile memory, when the setting change unit 26 detects the operation of changing the destination of the authentication request selected by the user. Subsequently, the setting change unit 26 displays the re-activation confirmation screen on the display unit of the operation panel unit 11 and waits a re-activation operation. When the user executes the re-activation operation, the multi-function apparatus 1 is re-activated. In consequence, in the process executed when the activation starts, it is determined whether the authentication information acquiring unit 24 normally operates on the basis of whether communication with the authentication server specified by the IP address stored in the non-volatile memory in S406 is possible.

With such a configuration, the administrator can execute the transfer to the setting change mode without use restriction of the use restriction unit 25 and can change the destination (the IP address of the authentication server) of the authentication request, even when the authentication information acquiring unit 24 does not normally operate and thus an obstacle occurs in the log-in function due to a problem with a communication path with the authentication server or a problem with the authentication server in the state where the log-in function is set to be valid. Accordingly, when the administrator selects another authentication server having no obstacle as a destination of the authentication request in the setting change mode and then the multi-function apparatus 1 is re-activated, the use desire user can receive authentication from the authentication server having no obstacle. Therefore, the user can continue to use the basic functions of the multi-function apparatus 1 under the use restriction of the use restriction unit 25.

In the above-described embodiment, the operation determination unit 27 is configured to determine whether the authentication device unit 15, the authentication information acquiring unit 24, the use restriction unit 25 each normally operate in S102. However, the operation determination unit 27 may be configured to determine whether one or two of these units (for example, only the authentication device unit 15) normally operate.

In the above-described embodiment, as the operation of the transfer to the setting change mode, the operation of pressing “VARIOUS KINDS OF SETTING” button disposed in the operation panel unit 11 and the subsequent operation of inputting the administrator password are defined. The operation of the transfer to the setting change mode may be defined in accordance with a design, as long as the operation of the transfer to the setting change mode includes an operation to be executed only by the administrator. For example, an operation of selecting an option indicating the operation of the transfer to the setting change mode displayed on the display unit and a subsequent operation of inputting the administrator password may be defined as the operation of the transfer to the setting change mode.

In the above-described embodiment, the use restriction unit 25 is configured to determine whether the use desire user has the use authority on the basis of the authentication result of the authentication server 4. However, the password of a qualified user is stored in advance in a non-volatile memory of the multi-function apparatus 1 and the use restriction unit 25 may determine whether the use desire user has the use authority (whether the use desire user is the qualified user) by comparing the stored password of the qualified user to a password input from the use desire user through the operation panel unit 11.

In the above-described embodiment, the authentication information acquiring unit 24 is configured to acquire the authentication information by use of the authentication device unit 15, that is, by use of the authentication device unit 15 as the authentication information inputting unit. However, the authentication information acquiring unit 24 is configured to acquire the authentication information by use of the operation panel unit 11, that is, by use of the operation panel unit 11 as the authentication information inputting unit, for example. In this case, the operation determination unit 27 determines whether the use restriction unit 25 normally operates.

The entire disclosure of Japanese Patent Application No. 2008-117218, filed Apr. 28, 2008 is expressly incorporated by reference herein.

What is claimed is:

1. A multi-function apparatus which has plural functions, comprising:
an authentication information acquiring unit which acquires authentication information on a user desiring to use the functions by use of an authentication information inputting unit;
a use restriction unit which determines whether the user desiring to use the functions has use authority on the basis of the acquired authentication information, and permits the user to use the functions on condition of determining that the user has the use authority;
an operation determination unit which determines whether at least one of the authentication information inputting unit, the authentication information acquiring unit, and the use restriction unit normally operates; and
a setting change unit which changes setting of the use restriction unit on the basis of an input from the user by executing transfer to a setting change mode on condition that an operation of the transfer to the setting change mode is executed by the user, when the unit determined not to normally operate is present.

2. The multi-function apparatus according to claim 1, wherein the setting change unit sets the use restriction unit to be invalid on the basis of the input from the user in the setting change mode.

3. The multi-function apparatus according to claim 1,
wherein the use restriction unit transmits an authentication request including the acquired authentication information to an authentication server, receives information on authentication success or failure from the authentication server in reply to the authentication request, and determines whether the user desiring to use the function has the use authority on the basis of the information on authentication success or failure,
wherein the operation determination unit determines that the use restriction unit does not normally operate, when the use restriction cannot receive the information on authentication success or failure due to an obstacle of the authentication server or a communication network, and
wherein the setting change unit changes a destination of the authentication request on the basis of the input from the user in the setting change mode, when the operation determination unit determines that the use restriction unit does not normally operate.

4. The multi-function apparatus according to claim 1, wherein an operation of the transfer to the setting change mode includes an input operation of an administrator password.

5. A method of restricting use of a multi-function apparatus which has plural functions, the method comprising:
acquiring authentication information on a user desiring to use the functions by use of an authentication information inputting unit;
determining whether the user desiring to use the functions has use authority on the basis of the acquired authentication information, and permitting the user to use the functions on condition of determining that the user has the use authority;
determining whether at least one of the authentication information inputting unit, the authentication information acquiring unit, and the use restriction unit normally operates; and
changing setting of the use restriction unit on the basis of an input from the user by executing transfer to a setting change mode on condition that an operation of the transfer to the setting change mode is executed by the user, when the unit determined not to normally operate is present.

6. A recording medium recorded a program causing a computer to execute the method according to claim 5.
